(19) United States
(12) Patent Application Publication
(10) Pub. No.: US 2021/0316902 A1
(43) Pub. Date: Oct. 14, 2021

(54) DEVICE FOR MEASURING THE TEMPERATURE OF A BEVERAGE BOTTLE

(71) Applicant: ELECTROLUX DO BRASIL S.A., Curitiba (BR)

(72) Inventors: Rodrigo Ferreira da SILVA, Curitiba (BR); Luis Fernando Zeni FILHO, Curitiba (BR); Gabriel PACHECO, Curitiba (BR); Marcelo FURMANN, Curitiba (BR); Mauri STÅHL, Curitiba (BR); Ramom Eduardo Gadens BADUY, Curitiba (BR); Wesley SAIKAWA, Curitiba (BR); Angela STELLA, Curitiba (BR)

(21) Appl. No.: 17/266,779

(22) PCT Filed: Aug. 21, 2018
(86) PCT No.: PCT/BR2018/050296

§ 371 Date: Feb. 8, 2021

(51) Int. Cl. B65D 23/16; A47G 23/02; B65D 23/00; B65D 23/10; G01J 5/00; G01J 5/02; G01J 5/08; G01K 1/024; G01K 1/143

(52) U.S. Cl. CPC B65D 23/16; A47G 23/0241; B65D 23/003; B65D 23/106; G01J 5/0037; G01K 2207/02; G01J 5/025; G01J 5/0893; G01K 1/024; G01K 1/143; G01J 5/0205

(57) ABSTRACT

A device (100; 200; 300; 400) comprising: a first arm (1051; 2051; 3051; 4051) adapted to accommodate and retain a bottle neck of a beverage bottle; a second arm (1052; 2052; 3052; 4052), extending from the first arm (1051; 2051; 3051; 4051), configured to extend towards a bottle body of the beverage bottle when the device (100; 200; 300; 400) is mounted on the beverage bottle; a temperature measuring unit (120), housed in the second arm (1052; 2052; 3052; 4052), facing the bottle body when the device (100; 200; 300; 400) is mounted on the beverage bottle, and a wireless communication unit (125) coupled to the temperature measuring unit (120) and adapted to wirelessly communicate with a display unit arranged to provide an indication associated with the temperature of the beverage bottle as measured by the temperature measuring unit (120).

### FIELD OF THE INVENTION

The present invention generally relates to a temperature measuring device. More particularly, the present invention relates to a device for measuring the temperature of a beverage bottle, such as a wine bottle. Even more particularly, the present invention relates to a device for measuring the temperature of a beverage bottle, such as a wine bottle, without having to open the beverage bottle and a refrigerating apparatus where the beverage bottle is stored during its cooling.

### BACKGROUND ART

In order to fully appreciate the flavour of a beverage, it is often desirable to serve the beverage at a particular temperature.

This is especially true for certain types of beverages, for example alcoholic beverages such as beer, cider and mead, and particularly for wine.

For example, white and sparkling wines are generally best served at cooler temperatures which play up fresh, fruity aspects while minimizing sweetness. Red wines may taste too harsh when chilled, due to the presence of tannins. Red wines, in particular old reds, are thus preferably served at warmer temperatures that allow their flavours and aromas to unfold. Serving a wine at a serving temperature different from its ideal serving temperature may result in a suboptimal wine tasting experience—for example, a temperature that is too cool may prevent a wine from properly unfolding and may also chill the gustatory papillae on the tongue, thus inhibiting the ability to distinguish sweet and sour flavours and thus further diminishing the tasting experience.

In addition, different varietals of red and white wines may have different ideal serving temperatures. Wine producers often indicate proper serving temperatures on wine bottle labels, so that a consumer may enjoy the wine at the temperature best suited to its type and characteristics.

However, it is extremely difficult for a wine consumer to set and control the ideal serving temperature for each specific type of wine.

The Applicant is aware of the presence of prior art solutions for determining the temperature of a beverage.

Some prior art solutions are based on the common approach of placing a probe in physical contact with the beverage.

Some prior art solutions are instead based on the common approach of placing a temperature sensor in physical contact with the beverage bottle. For example, US2006026971 discloses a system for determining and monitoring wine temperature. The system includes a housing, a first temperature sensor for sensing an ambient temperature and a second temperature sensor for sensing the temperature of a wine bottle, for example without opening the bottle. A processor processes the ambient temperature with the wine bottle temperature to determine the temperature of wine within the bottle. A user may select a target wine temperature, which may further be displayed. The system may fit around the neck of the wine bottle or over the cork of the wine bottle, or the system may be configured as a coaster. Sensors may be contact or non-contact sensors such as infrared sensors. In one embodiment, an infrared system for determining and monitoring wine temperature is provided as a bottle stopper that replaces the cork of a wine bottle.

### SUMMARY OF THE INVENTION

The Applicant has noticed that the prior art solutions are not satisfactory.

In fact, the Applicant has understood that placing a probe in physical contact with the beverage, and particularly wine, can contaminate the beverage and alter its taste, for example due to residues left on the probe from measurements of prior beverages, or even detergents used to clean the probe between measurements.

The Applicant has also understood that the known prior art solutions based on placing a temperature sensor in physical contact with the beverage bottle are generally inadequate for measuring and achieving optimal beverage drinking temperatures.

Considering for example the above cited document US2006026971, the solution disclosed in such a document only allows an approximate measurement of the temperature of the wine. In fact, when positioning the temperature sensor around the neck of the wine bottle or over the cork of the wine bottle, or at a base of the wine bottle, a non-uniform and non-planar surface of the wine bottle is “intercepted” by the o temperature sensor (in that the bottle neck has a high curvature and the bottle base has an irregular shape, due to the presence of a punt that allows easily holding the beverage bottle and to catch sediments at the bottom), and hence temperature measurements typically do not comply with the degree of accuracy that wine tasting needs.

The present invention is addressed to overcome the above-mentioned, as well as other, issues.

In particular, one or more aspects of the present invention are indicated in the independent claims, with advantageous features of the same invention that are indicated in the dependent claims, whose text is incorporated herein verbatim by reference.

More specifically, an aspect of the present invention proposes a device. The device preferably comprises:

a first arm preferably adapted to accommodate and retain a bottle neck of a beverage bottle, such as a wine bottle;

a second arm preferably extending from the first arm, the second arm being preferably configured to extend towards a bottle body of the beverage bottle when the device is mounted on the beverage bottle;

a temperature measuring unit preferably housed in the second arm, the temperature measuring unit preferably facing the bottle body when the device is mounted on the beverage bottle, and

a wireless communication unit preferably coupled to the temperature measuring unit.

The wireless communication unit is preferably adapted to wirelessly communicate with a display unit preferably arranged to provide an indication associated with the temperature of the beverage bottle as measured by the temperature measuring unit.

According to an embodiment of the present invention, the first arm comprises at least one hooking element for hooking the device to a support element thereby allowing the beverage bottle to be supported in a hanged position.

According to an embodiment of the present invention, the first arm comprises a clamping member, preferably an adjustable clamping member, for accommodating and retaining the bottle neck of the beverage bottle.

According to an embodiment of the present invention, the first arm comprises an opening for accommodating and retaining the bottle neck of the beverage bottle.

According to an embodiment of the present invention, said opening comprises a first portion for the passage of the bottle neck through it, and, preferably, a second portion, preferably reduced in size with respect to the first portion, for accommodating and retaining the bottle neck of the beverage bottle.

According to an embodiment of the present invention, said opening is an adjustable opening that is adjustable according to a size of the bottle neck. Preferably, the device further comprises an adjustable clamping member defining said adjustable opening and retaining the bottle neck of the beverage bottle.

According to an embodiment of the present invention, the adjustable clamping member comprises:
first and second semicircular portions, preferably moveable with respect to each other along a moving direction, a distance between the first and second semicircular portions along said moving direction preferably defining said adjustable opening, and
a locking system for locking in a releasable manner the first and second semicircular portions to each other around, and preferably in contact to, the bottle neck.

According to an embodiment of the present invention, the device further comprises a release mechanism for allowing the user to selectively release the locking of the first and second semicircular portions.

According to an embodiment of the present invention, the adjustable clamping member comprises:
first and second semicircular portions, a first end of the first semicircular portion being preferably hinged to a first end of the second semicircular portion whereby the first and second semicircular portions are rotatable with respect to each other;
a locking system for locking, preferably in a releasable manner, a second end of the first semicircular portion to a second end of the second semicircular portion around, and preferably in contact to, the bottle neck, a distance between the second ends of the first and second semicircular portions preferably defining said adjustable opening.

According to an embodiment of the present invention, the adjustable clamping member comprises a tie adapted to be fitted into, and preferably engage, a receptacle to form a (e.g., releasable) ratchet mechanism, a fitting extent of the tie into the receptacle preferably defining said adjustable opening.

According to an embodiment of the present invention, the adjustable clamping member comprises, preferably on at least part of a contact region thereof that in use is in contact with the bottle neck, a grip element for improving an adherence between the contact region and the bottle neck of the beverage bottle.

According to an embodiment of the present invention, the device comprises a flexible region for causing at least part of the second arm to resiliently flex with respect to the first arm thereby allowing the second arm to adapt to a size of the bottle body.

According to an embodiment of the present invention, the flexible region comprises a region of the second arm having a thickness lower than the thickness of the rest of the second arm.

According to an embodiment of the present invention, the flexible region comprises a hinging element preferably arranged between the first and second arms or between first and second regions of the second arm.

According to an embodiment of the present invention, the flexible region comprises a region of the second arm having a flexible material overmolded thereon.

According to an embodiment of the present invention, the wireless communication unit is adapted to wirelessly communicate with a mobile computing apparatus, such as a smartphone, comprising said display unit.

According to an embodiment of the present invention, the wireless communication unit is configured to wirelessly communicate based on at least one wireless communication mode among Wi-Fi communication, Bluetooth communication and radio frequency communication.

According to an embodiment of the present invention, the wireless communication unit is configured to select the wireless communication mode based on a current distance between the device and the mobile computing apparatus.

According to an embodiment of the present invention, the device further comprises a temperature indicator, preferably located on the second arm, and in wireless or wired communication with the temperature measuring unit; said temperature indicator is advantageously configured to provide said indication associated with the temperature of the beverage bottle as measured by the temperature measuring unit.

According to an embodiment of the present invention, the first and second arms define a substantially L-shaped profile of the device.

According to an embodiment of the present invention, the at least one hooking element is in correspondence of a first free end of the first arm. The second arm advantageously has a first end coupled to a second end of the first arm preferably opposite to the first free end of the first arm; the second arm advantageously has a second free end opposite to the first end of the second arm.

According to an embodiment of the present invention, the temperature measuring unit is located in intermediate position along the second arm, particularly closer to the second free end thereof than to the first end thereof.

According to an embodiment of the present invention, the at least one hooking element is formed in a single piece with the first arm.

According to an embodiment of the present invention, the first and second arms are made in a single piece.

According to an embodiment of the present invention, said indication associated with the temperature of the beverage bottle provided by the display unit comprises an indication that the beverage bottle has reached a target temperature.

Another aspect of the present invention relates to a device adapted to be coupled to a beverage bottle, such as a wine bottle. The device preferably comprises one or more among:

a clamping member for accommodating and retaining the bottle neck of the beverage bottle,

at least one hooking element for hooking the device to a support element thereby allowing the beverage bottle to be supported in a hanged position;

a temperature measuring unit, the temperature measuring unit preferably facing the beverage bottle when the device is coupled to the beverage bottle, and

a wireless communication unit preferably coupled to the temperature measuring unit and preferably adapted to wirelessly communicate with a display unit preferably arranged to provide an indication associated with the temperature of the beverage bottle as measured by the temperature measuring unit.

According to an embodiment of the present invention, the device further comprises at least one among:

a first part preferably comprising said at least one hooking element, and

a second part preferably adapted to accommodate said temperature measuring unit.

According to an embodiment of the present invention, the first part of the device also comprises said clamping member.

According to an embodiment of the present invention, the first part is in the form of a first arm, and the second part is in the form of a second arm preferably extending from the first arm towards a bottle body of the beverage bottle when the device is mounted on the beverage bottle.

According to an embodiment of the present invention, the clamping member comprises an opening for accommodating and retaining the bottle neck of the beverage bottle.

According to an embodiment of the present invention, said opening comprises a first portion for the passage of the bottle neck through it, and, preferably, a second portion, preferably reduced in size with respect to the first portion, for accommodating and retaining the bottle neck of the beverage bottle.

According to an embodiment of the present invention, said opening is an adjustable opening that is adjustable preferably according to a size of the bottle neck, said clamping member being for example an adjustable clamping member defining said adjustable opening and retaining the bottle neck of the beverage bottle.

According to an embodiment of the present invention, the adjustable clamping member comprises at least one among:
first and second (e.g., semicircular) portions moveable with respect to each other along a moving direction, a distance between the first and second semicircular portions along said moving direction advantageously defining said adjustable opening, and
a locking system for locking (e.g., in a releasable manner) the first and second semicircular portions to each other around, and preferably in contact to, the bottle neck.

According to an embodiment of the present invention, the device further comprises a release mechanism for allowing the user to (e.g., selectively) release the locking of the first and second semicircular portions.

According to an embodiment of the present invention, the adjustable clamping member comprises at least one among:
first and second semicircular portions, a first end of the first semicircular portion being preferably hinged to a first end of the second semicircular portion whereby the first and second semicircular portions are rotatable with respect to each other;
a locking system for locking (for example in a releasable manner) a second end of the first semicircular portion to a second end of the second semicircular portion around (and preferably in contact to) the bottle neck, a distance between the second ends of the first and second semicircular portions preferably defining said adjustable opening.

According to an embodiment of the present invention, the adjustable clamping member comprises a tie adapted to be fitted into (and preferably engage) a receptacle to form a (e.g., releasable) ratchet mechanism, said tie preferably defining said adjustable opening.

According to an embodiment of the present invention, the adjustable clamping member comprises, preferably on at least part of a contact region thereof that in use is in contact with the bottle neck, a grip element for improving an adherence between the contact region and the bottle neck of the beverage bottle.

According to an embodiment of the present invention, the device comprises a flexible region for causing at least part of the second arm to resiliently flex with respect to the first arm thereby allowing the second arm to adapt to a size of the bottle body.

According to an embodiment of the present invention, the flexible region comprises a region of the second arm having a thickness lower than the thickness of the rest of the second arm.

According to an embodiment of the present invention, the flexible region comprises a hinging element preferably arranged between the first and second arms or between first and second regions of the second arm.

According to an embodiment of the present invention, the flexible region comprises a region of the second arm having a flexible material overmolded thereon.

According to an embodiment of the present invention, the wireless communication unit is adapted to wirelessly communicate with a mobile computing apparatus, such as a smartphone, comprising said display unit.

According to an embodiment of the present invention, the wireless communication unit is configured to wirelessly communicate based on at least one wireless communication mode among Wi-Fi communication, Bluetooth communication and radio frequency communication.

According to an embodiment of the present invention, the wireless communication unit is configured to select the wireless communication mode based on a current distance between the device and the mobile computing apparatus.

According to an embodiment of the present invention, the device further comprises a temperature indicator preferably located on the device and preferably in wireless or wired communication with the temperature measuring unit; the temperature indicator is advantageously configured to provide said indication associated with the temperature of the beverage bottle as measured by the temperature measuring unit.

According to an embodiment of the present invention, the first and second arms define a substantially L-shaped profile of the device.

According to an embodiment of the present invention, the at least one hooking element is in correspondence of a first free end of the first arm, the second arm preferably having a first end coupled to a second end of the first arm preferably opposite to the first free end of the first arm. The second arm preferably has a second free end, preferably opposite to the first end of the second arm.

According to an embodiment of the present invention, the temperature measuring unit is located in intermediate position along the second arm, particularly closer to the second free end thereof than to the first end thereof.

According to an embodiment of the present invention, the at least one hooking element is formed in a single piece with the first arm.

According to an embodiment of the present invention, the first and second arms are made in a single piece.

According to an embodiment of the present invention, wherein said indication associated with the temperature of the beverage bottle provided by the display unit comprises an indication that the beverage bottle has reached the target temperature.

Another aspect of the present invention relates to a system. The system preferably comprises:

a device adapted to be mounted on a beverage bottle, wherein the device preferably comprises a temperature measuring unit preferably facing the bottle body when the device is mounted on the beverage bottle, and preferably a wireless communication unit coupled to the temperature measuring unit,

a beverage bottle database, and

a mobile computing apparatus, such as a smartphone, comprising a display unit, the mobile computing apparatus being preferably adapted to:
read a label on the beverage bottle;
access the beverage bottle database and preferably retrieve from it a target temperature for the beverage bottle preferably according to the label being read on the beverage bottle;
wirelessly communicate with the wireless communication unit for receiving the temperature of the beverage bottle as measured by the temperature measuring unit, and
notify, for example by displaying on the display unit, an indication associated with the temperature of the beverage bottle as measured by the temperature measuring unit, said indication associated with the temperature of the beverage bottle preferably comprising an indication of the temperature of the beverage bottle with respect to the target temperature.

According to an embodiment of the present invention, said indication associated with the temperature of the beverage bottle comprises one or more among a current temperature of the beverage bottle, temperature of the beverage bottle below and/or above and/or within a specified temperature range, and estimated cooling time to reach the target temperature.

According to an embodiment of the present invention, said beverage bottle database is a local database locally stored in the mobile computing apparatus or a remote database remotely accessed by the mobile computing apparatus.

A further aspect of the present invention relates to a refrigerating apparatus. The refrigerating apparatus preferably comprises a refrigerating compartment and a door for selectively closing the refrigerating compartment. Said door preferably comprises an external surface that preferably forms an external appearance of the refrigerating apparatus. The door preferably comprises an inner liner, preferably opposite to said external surface and facing, when the door is closed, the refrigerating compartment: the inner liner advantageously comprises one or more support elements for supporting one or more storage elements preferably adapted to store products to be refrigerated. The refrigerating apparatus advantageously comprises the device of any of the above embodiments, the device being so advantageously adapted to be hung on said one or more support elements, e.g. through the at least one hooking element.

### BRIEF DESCRIPTION OF THE FIGURES

One or more embodiments of the present invention, as well as further features and the related advantages, will be better understood with reference to the following detailed description, given purely by way of non-limitative example only, to be read in conjunction with the accompanying figures (wherein corresponding elements are indicated with the same or similar references and their explanation is not repeated for the sake of brevity). In particular:

FIG. 1A shows side and front views of a device according to an embodiment of the present invention;

FIG. 1B shows a perspective and partly exploded view of said device according to an embodiment of the present invention;

FIG. 1C shows the device of FIGS. 1A and 1B mounted on beverage bottles having different sizes, according to an embodiment of the present invention;

FIG. 2A shows front and size views of a device according to another embodiment of the present invention;

FIGS. 2B, 2C and 2D show a perspective view, a partly exploded perspective view, and a perspective view with partly removed parts, respectively, of a portion of the device of FIG. 2A, according to an embodiment of the present invention;

FIGS. 3A and 3B show perspective side views of a device according to another embodiment of the present invention;

FIG. 3C shows a perspective and partially exploded side view of the device of FIGS. 3A and 3B according to an embodiment of the present invention;

FIG. 4A shows a perspective side view of a device according to another embodiment of the present invention;

FIGS. 4B and 4C show a view from above and a sectional view from above, respectively, of the device of FIG. 4A according to an embodiment of the present invention;

FIG. 5A shows a perspective view of a refrigerating apparatus on which the device of FIGS. 1A to 4C may be supported in a hanged position, according to an embodiment of the present invention, and

FIG. 5B shows a perspective view of a door of the refrigerating apparatus of FIG. 5A and a device/beverage bottle assembly supported on it in the hanged position, according to an embodiment of the present invention.

### DESCRIPTION OF EMBODIMENTS OF THE INVENTION

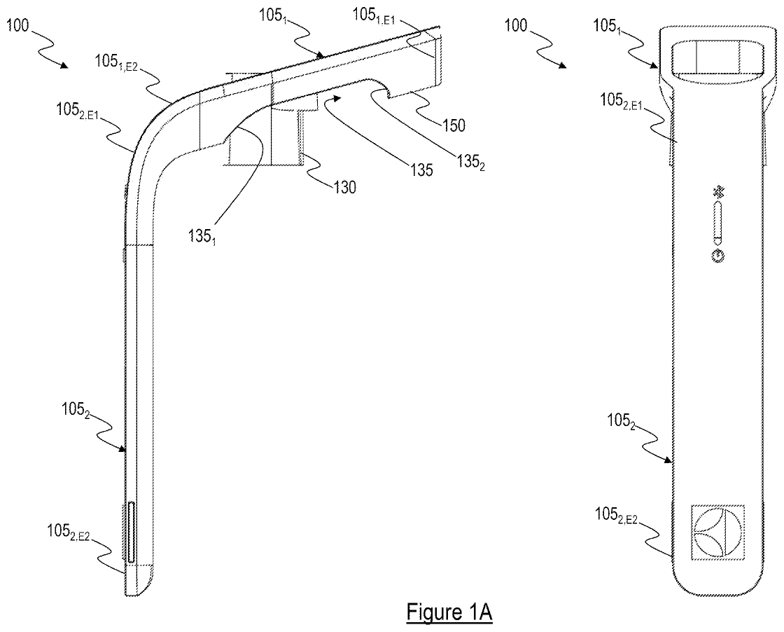

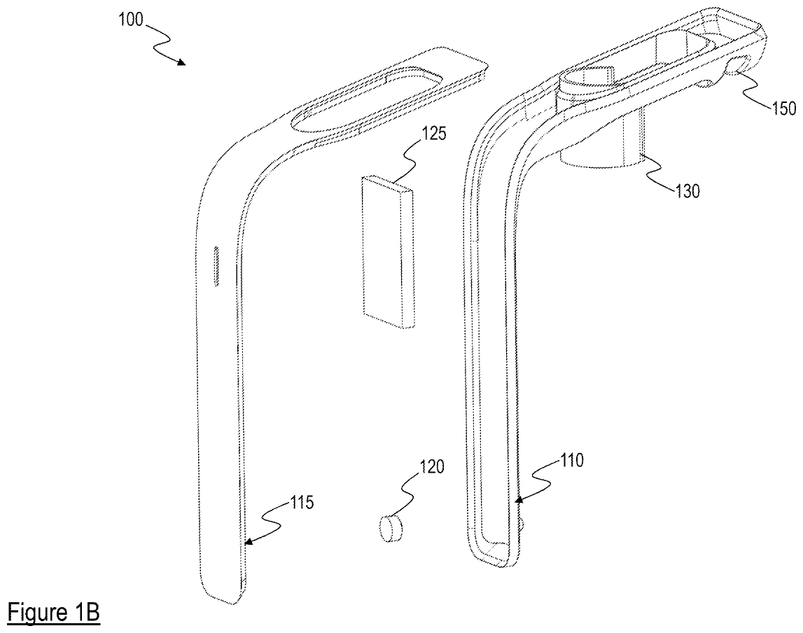

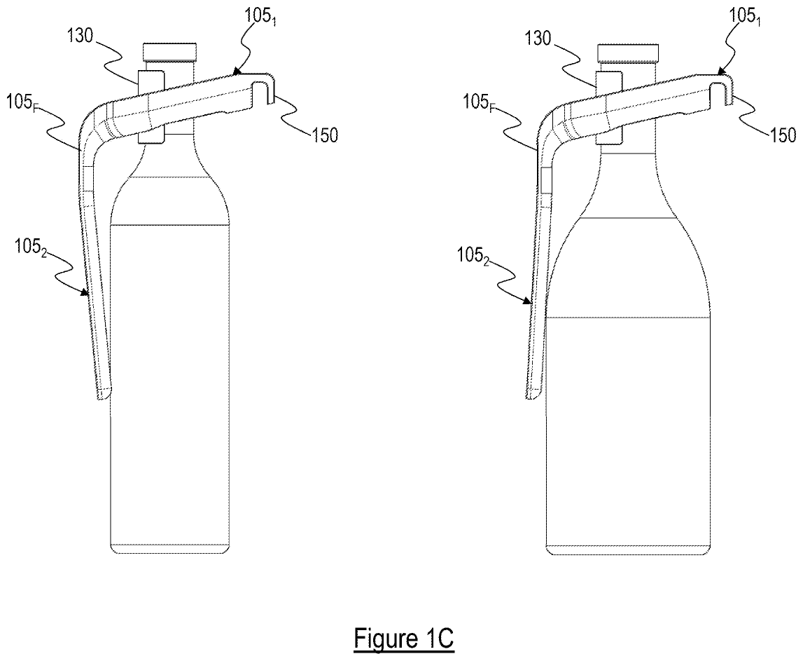

With reference to the drawings, FIG. 1A shows side and front views of a device 100 according to an embodiment of the present invention, and FIG. 1B shows a perspective and partly exploded view of the device 100 according to an embodiment of the present invention. Broadly speaking, the device 100 is an accessory adapted to be mounted on a beverage bottle (for example, a wine bottle) for measuring a temperature thereof and for providing a corresponding indication to a user (e.g., a consumer of the wine bottle). In the following, directional terminology (for example, outer, inner, longitudinal, vertical, transverse) associated with the device 100 and components or parts thereof will be used only in connection with their orientation in the figures, which is assumed to be their orientation of use (i.e., the orientation taken when the device 100 is mounted on the beverage bottle and the resulting device/bottle assembly is arranged in a refrigerating apparatus). Moreover, the term “substantially” will be used to take into account (desired or undesired) manufacturing tolerances.

The device 100 comprises a first arm 105₁ adapted to accommodate and retain a bottle neck of the beverage bottle (not shown in these figures), and a second arm 105₂ extending from the first arm and configured to extend towards a bottle body of the beverage bottle when the device 100 is mounted on the beverage bottle—the second arm 105₂ preferably extending to a substantially intermediate region of the bottle body, i.e. essentially in correspondence of a middle of bottle body.

Preferably, as illustrated, the first 105₁ and second 105₂ arms define a substantially L-shaped profile of the device 100. The first arm 105₁ preferably identifies, in use, a substantially horizontal arm, and the second arm 105₂ preferably identifies, in use, a substantially vertical arm—for ease of description, from now on the first 105₁ and second 105₂ arms are will be roughly referred to as horizontal 105₁ and vertical 105₂ arms, respectively.

Preferably, the horizontal arm 105₁ comprises a first, free end 105_{1,E1} (that, as better discussed in the following, is preferably associated with a hanging function of the device 100) and a second end 105_{1,E2} opposite to the first end 105_{1,E1}, and the vertical arm 105₂ comprises a first end 105_{2,E1} coupled to the second end 105_{1,E2} of the horizontal arm 105₁, and a second, free end 105_{2,E2} opposite to the first end 105_{2,E1} (in correspondence of which, as better discussed in the following, a temperature measuring function of the device 100 preferably takes place). The horizontal 105₁ and vertical 105₂ arms are advantageously made in a single piece.

As visible in FIG. 1B, the device 100 preferably comprises an inner shell 110 that, when the device 100 is mounted on the beverage bottle, is (at least partially) in contact with the beverage bottle, and an outer shell 115 adapted to superimpose to and cover the inner shell 110; the inner 110 and outer 115 shells are advantageously shaped such that, upon superimposition (and coupling) of the outer shell 115 onto the inner shell 110, a gap is defined therebetween for housing one or more electronic components (e.g. including one or more among a temperature measuring unit, a wireless communication unit and wire electrical connections, as better discussed in the following).

Preferably, the inner shell 110 is made of a plastic and at least partially resilient material. More preferably, the inner shell 110 is made of a plastic material exhibiting suitable frictional properties when in contact with the beverage bottle. Even more preferably, the inner shell 110 (or at least most of it) is made of a substantially thermally insulating material, so as to protect the electronic components against issues associated with low temperature environments and conditions where rapid changes of temperature are expected (such as when the device/bottle assembly is placed in the refrigerating apparatus).

Preferably, the outer shell 115 comprises or is made of a rigid material. More preferably, the outer shell 115 (or at least a surface thereof that, when the device 100 is mounted on the beverage bottle, is visible to the user) comprises or is made of a material featuring aesthetical appeal for the user. Even more preferably, the outer shell 115 comprises or is made of stainless steel.

Advantageously, the inner 110 and outer 115 shells are coupled to each other by known molding or overmolding techniques.

As visible in FIG. 1B, the inner 110 and outer 115 shells comprise each one respective horizontal and vertical arms, the horizontal arm of the inner shell 110 being preferably made in a single piece with the vertical arm of the inner shell 110, and the horizontal arm of the outer shell 115 being preferably made in a single piece with the vertical arm of the outer shell 115. When the inner 110 and outer 115 shells are superimposed and coupled to each other, the horizontal arms of the inner 110 and outer 115 shells identify, as a whole, the horizontal arm 105₁ of the device 100, and the vertical arms of the inner 110 and outer 115 shells identify, as a whole, the vertical arm 105₂ of the device 100.

In the following, reference will be mainly made to the horizontal 105₁ and vertical 105₂ arms of the device 100 (i.e. the horizontal arms of the inner 110 and outer 115 shells considered as a whole, and the vertical arms of the inner 110 and outer 115 shells considered as a whole), exception made when it will be necessary to distinguish between the horizontal and vertical arms of the inner shell 110 and the horizontal and vertical arms of the outer shell 115. In any case, when referring to a feature or part or portion or element or region of the horizontal arm 105₁ or of the vertical 105₂ arm of the device 100, that feature or part or portion or element or region is meant to be equivalently found, respectively, in both the horizontal arms of the inner 110 and outer 115 shells or in both the vertical arms of the inner 110 and outer 115 shells, unless otherwise indicated. Just as an example, the horizontal arms of the inner 110 and outer 115 shells comprise respective first and second ends that, when the inner 110 and outer 115 shells are superimposed and coupled to each other, identify as a whole the first 105_{1,E1} and second 105_{1,E2} ends of the horizontal arm 105₁, respectively, of the device 100; similarly, the vertical arms of the inner 110 and outer 115 shells comprise respective first and second ends that, when the inner 110 and outer 115 shells are superimposed and coupled to each other, identify as a whole the first 105_{2,E1} and second 105_{2,E2} ends of the vertical arm 105₂, respectively, of the device 100.

Preferably, the device 100 comprises a temperature measuring unit 120 housed in the vertical arm 105₂ for measuring, when the device 100 is mounted on the beverage bottle, the temperature of the beverage bottle (and hence of the beverage contained therein, in that a thermal equilibrium between the beverage bottle and the content is expected). More preferably, the temperature measuring unit 120 is located in an intermediate position along the vertical arm 105₂ of the device 100, the temperature measuring unit 120 being for example located closer to the second end 105_{2,E2} of the vertical arm 105₂ than to its first end 105_{2,E1} (as visible in FIG. 1B). Locating the temperature measuring unit 120 far or relatively far from the bottle neck and far or relatively far from a bottle base (due to the fact that the vertical arm 105₂ extends to a substantially intermediate region of the bottle body and to the fact that the temperature measuring unit 120 is located at the second end 105_{2,E2} of the vertical arm 105₂) is advantageous in that a more uniform and planar surface of the beverage bottle can be “intercepted” by the temperature measuring unit 120 in correspondence of the bottle body as compared to the surface of the beverage bottle provided at the bottle neck (which has a high curvature) or at the bottle base (which, due to the presence of a punt that allows easily holding the beverage bottle and to catch sediments at the bottom, has an irregular shape). Depending on the physical principle on which the temperature measuring unit 120 is based, a uniform and planar surface “intercepted” by the temperature measuring unit 120 may result in more accurate temperature measurements by the temperature measuring unit 120.

Preferably, the temperature measuring unit 120 is accommodated on (for example, fixed to) the vertical arm of the inner shell 110, and faces the bottle body when the device 100 is mounted on the beverage bottle.

According to the preferred embodiment of the present invention herein considered, the temperature measuring unit 120 is an infrared sensor, i.e. a sensor or thermometer which infers temperature from a portion of a thermal radiation (sometimes called black-body radiation) emitted by the object being measured. However, the temperature measuring unit 120 may be any sensor included in the family of thermal radiation thermometers.

According to a first implementation, in order to achieve efficient infrared radiation propagation between the temperature measuring unit 120 (i.e., an infrared transceiver section thereof) and the bottle body, an opening (not shown) may be provided in the vertical arm of the inner shell 110 for exposing at least the infrared transceiver section (with shape and size of the opening that preferably match shape and size of the infrared transceiver section).

According to a second implementation, in order to achieve efficient infrared radiation propagation between the temperature measuring unit 120 (i.e., the infrared transceiver section thereof) and the bottle body, the infrared transceiver section of the temperature measuring unit 120 may face an infrared transparent window (i.e., a window made of a material that allows passage of the infrared radiation unaltered or essentially unaltered, not shown) provided in the vertical arm of the inner shell 110, wherein shape and size of the infrared transparent window preferably match shape and size of the infrared transceiver section of the temperature measuring unit 120. Advantageously, the infrared transparent window of the inner shell 110 comprises ZnSe—Zinc selenide.

According to an alternative embodiment of the present invention, the temperature measuring unit 120 is in thermal coupling with the bottle body when the device 100 is mounted on the beverage bottle. In this case, the temperature measuring unit 120 may for example be based on thermistors, such as NTC thermistors (i.e. resistors whose resistances decrease as temperature increase), the temperature measuring unit 120 being for example an integrated circuit comprising one or more thermistors as well as electronic circuits embedded in a package of plastic material, and a thermally conductive sensing pad (not shown) exposed on a surface of the package for allowing effective transfer of the heat information from the surface of the beverage bottle to the thermistor(s). The thermally conductive sensing pad of the temperature measuring unit 120 may for example comprise silicone, which ensures good thermal conductivity properties and exhibits a good surface contact with the bottle body (thereby accommodating surface imperfections of the material of the bottle body or of other components between the thermally conductive sensing pad and the bottle body). Preferably, the thermally conductive sensing pad of the temperature measuring unit 120 also comprises a thermally insulating portion, more preferably a thermally insulating perimeter portion surrounding the thermally conductive sensing pad, so as to avoid interference in the temperature sensing from air currents; just as an example, the thermally insulating portion may comprise a closed cell rubber tape.

According to a first implementation of the temperature measuring unit 120 in thermal coupling with the bottle body, in order to achieve efficient thermal coupling between the temperature measuring unit 120 and the bottle body, the thermally conductive sensing pad of the temperature measuring unit 120 faces and is in direct (and, hence, in both mechanical and thermal) contact with the bottle body; this may for example be achieved by means of an opening (not shown) provided in the vertical arm of the inner shell 110, wherein shape and size of the opening preferably match shape and size of the thermally conductive sensing pad. Therefore, according to this implementation, the thermally conductive sensing pad of the temperature measuring unit 120 is exposed from the opening provided in the vertical arm of the inner shell 110, and directly contacts the bottle body (with the above mentioned thermally insulating portion that may for example surround such an opening).

According to a second implementation of the temperature measuring unit 120 in thermal contact with the bottle body, in order to achieve efficient thermal coupling between the temperature measuring unit 120 and the bottle body, the thermally conductive sensing pad of the temperature measuring unit 120 may face and be in thermal contact with the bottle body without directly contacting it mechanically; this may for example be achieved by means of a thermally conductive window (not shown) provided in the vertical arm of the inner shell 110, wherein shape and size of the thermally conductive window preferably match shape and size of the thermally conductive sensing pad (with the above mentioned thermally insulating portion that may for example surround such a thermally conductive window).

Advantageously, the thermally conductive window of the inner shell 110 comprises silicone, which ensures good thermal conductivity properties and exhibits a good surface contact with the bottle body and with the thermally conductive sensing pad of the temperature measuring unit 120.

Irrespective of the actual technology or principle used for measuring the temperature, a package of the temperature measuring unit 120 is advantageously coated (e.g., wholly or partially) with a coating for protecting it against problems associated with low temperature environments such as fridges and conditions where rapid changes of temperature are expected (such as high levels of condensation). The coating may for example be a conformal coating, which prevents ionizable contaminants such as salts from reaching the electronic circuits.

The vertical arm 105₂ of the device 100 preferably comprises a flexible region for causing at least part of the vertical arm 105₂ to resiliently flex with respect to the horizontal arm 105₁ thereby allowing the vertical arm 105₂ to adapt to the size of the bottle body and, hence, to achieve a very close distance or even adherence between the temperature measuring unit 120 and the bottle body—so as to obtain either an efficient optical coupling when the temperature measuring unit 120 is an infrared sensor, or an efficient thermal coupling when the temperature measuring unit 120 is based on thermistor(s). The resilient flexing of the vertical arm 105₂ with respect to the horizontal arm 105₁ in presence of beverage bottles with different bottle body sizes is shown in FIG. 1C (the flexible region being denoted by the number reference 105_{F} in this figure).

The resilient properties of flexible region advantageously allow the vertical arm 105₂ to be rotated with respect to the horizontal arm 105₂ from a rest (i.e., absence of a bottle body), to an operative condition (i.e., presence of the bottle body), in which the rotation of the vertical arm 105₂ is essentially determined by the specific size of the bottle body (as visible in FIG. 1C). The close distance or adherence between the temperature measuring unit 120 and the bottle body (in order to achieve efficient optical coupling or thermal coupling or contact therebetween) is determined by natural resilient rotation of the vertical arm 105₂ back to its rest condition.

According to an embodiment of the present invention, the flexible region 105_{F} comprises a region of the vertical arm 105₂ having a thickness lower than the thickness of the rest of the second arm 105₂. Additionally or alternatively, the flexible region 105_{F} may comprise a hinging element, not shown, arranged between the horizontal 105₁ and vertical 105₂ arms or between regions of the vertical arm 105₂. Additionally or alternatively, the flexible region 105_{F} may comprise a region of the vertical arm 105₂ having a flexible material overmolded thereon (the flexible material for example surrounding both the inner 110 and outer 115 shells).

Irrespective of the specific implementation, the position of the flexible region 105_{F} may take into account design options, such as length of the vertical arm 105₂ and/or position of the temperature measuring unit 120 along it.

Back to FIG. 1B, the device 100 preferably comprises a wireless communication unit 125 coupled (e.g. by means of electric wires, not shown) to the temperature measuring unit 120 for receiving from it the measured temperature of the beverage bottle, and is adapted to wirelessly communicate with a display unit (or with an apparatus equipped with a display unit), not shown in this figure, arranged to provide an indication associated with the temperature of the beverage bottle as measured by the temperature measuring unit 120.

An example of apparatus equipped with a display unit is a mobile computing apparatus, such as a smartphone (not shown in this figure), to which reference will be made from now on by way of example only.

As will be better discussed in the following, the wireless communication unit 125 may be configured to communicate with the smartphone for either notification purposes (such as for providing the measured temperature of the beverage bottle) or for setting purposes (such as for setting target or ideal serving temperatures or temperature ranges of the beverage bottle to be notified to the smartphone of the user, and/or for enabling power on and off of the device 100, as better discussed below).

The wireless communication unit 125 may be configured to wirelessly communicate with the smartphone based on one or more wireless communication modes among Wi-Fi communication, Bluetooth™ communication and radio frequency communication. Advantageously, the wireless communication unit 125 supports all the above, as well as other, communication modes, and may communicate with the smartphone according to the communication mode(s) supported by the smartphone. More advantageously, the wireless communication unit 125 may communicate with the smartphone by means of the less energy consuming communication mode(s) supported by both the wireless communication unit 125 and the smartphone.

Additionally or alternatively, the wireless communication unit 125 may be configured to select the wireless communication mode based on a current distance between it (or, equivalently, the device 100) and the smartphone. In order to achieve that, the communication between the wireless communication unit 125 and the smartphone may take place either directly by means of a short range wireless communication (such as Bluetooth™ communication or Wi-Fi direct communication) if the smartphone and the wireless communication unit 125 are within a maximum range supported by the short-range wireless communication, or indirectly by means of a medium or long-range wireless communication (such as a Wi-Fi or Cloud communication) if the smartphone and the wireless communication unit 125 are outside the maximum range supported by the short-range wireless communication.

As a further embodiment, additional or alternative to the above embodiments, the temperature measuring unit 120 may be in wireless or wired communication with a temperature indicator (not shown) of the device 100. The temperature indicator is advantageously adapted to provide an indication associated with the temperature of the beverage bottle as measured by the temperature measuring unit 120 (and, preferably, information associated with the beverage bottle), and is preferably placed in a position of the device 100 that can be easily viewed by the user, such as on the horizontal arm 105₁ or, even better, on the vertical arm 105₂ (placing the temperature indicator on the vertical arm 105₂ is particularly preferred in the considered embodiments of the present invention, discussed in the following, in which the horizontal arm 105₁ is already intended to accomplish hooking and retaining functions). More preferably, the temperature indicator is placed on the horizontal arm or, even better, on the vertical arm of the outer shell 115 (which is the shell that, when the device 100 is mounted on the beverage bottle, is visible to the user).

The indication associated with the temperature of the beverage bottle provided by the temperature indicator may for example comprise one or more indications among a current temperature of the beverage bottle, a target temperature, a temperature of the beverage bottle below and/or above and/or within a specified temperature range, and/or an estimated cooling time to reach the target temperature when the device/bottle assembly is placed in the refrigerating apparatus; according to embodiments of the present invention, this one or more indications may be displayed by the temperature indicator in the form of texts and/or colors. The information associated with the beverage bottle preferably provided by the temperature indicator may for example comprise type of beverage and origin (e.g., country of production); according to embodiments of the present invention, this information may be displayed by the temperature indicator in the form of texts.

The device 100 may preferably comprise a power supply module, not shown, electrically coupled (e.g. by means of electric wires, not shown) to the wireless communication unit 125, the temperature measuring unit 120 and the temperature indicator (if provided), for powering them (i.e., for supplying them with respective electric voltages and currents required for their operation). The power supply module may for example comprise a battery, for example a replaceable battery (not shown). Advantageously, a switch (not shown), for example a micro-switch, may be provided for enabling the device 100 to be powered on and off to preserve battery life. More advantageously, the switch may be arranged such that it is in an open position (device 100 powered off) until it is depressed. Even more advantageously, the switch may be arranged such that when the device 100 is mounted on a beverage bottle and a close fit by between the device 100 and the beverage bottle is achieved, the close fit may cause the switch to be pressed thereby enabling power on of the device 100 (and, particularly, power on of the wireless communication unit 125, of the temperature measuring unit 120 and, if provided, of the temperature indicator). Still more advantageously, one or more status indicators (not shown), for example one or more LED indicators, may be provided (for example, on the outer shell 110) to indicate whether the device 100 has turned on correctly. Additionally or alternatively to the (mechanical) switch, the device 100 may be so powered on and off remotely (i.e., without necessarily pressing and depressing a mechanical switch physically provided on the device 100); by way of example only, in the considered example of a smartphone as a mobile computing apparatus equipped with the display unit, the device 100 may be wirelessly powered on and off by means of a dedicated function provided in an application run in the smartphone (discussed in the following).

As mentioned above, the horizontal arm 105₁ of the device 100 is adapted to accommodate and retain the bottle neck of the beverage bottle.

Preferably, the horizontal arm 105₁ of the device 100 comprises an opening for accommodating and retaining the bottle neck of the beverage bottle.

According to an embodiment of the present invention, not shown, said opening comprises an elongated through hole comprising a first hole portion for the passage of the bottle neck through it, and a second hole portion, advantageously reduced in size with respect to the first hole portion, for accommodating and retaining the bottle neck of the beverage bottle. The first and second hole portions may for example be obtained by through holes, having same or substantially same gradually narrowing elongated profiles, formed on the horizontal arms of the inner 110 and outer 115 shells (such that, upon superimposition and coupling of the inner 110 and outer 115 shells to each other the first and second hole portions are defined). In operation, the bottle neck of the beverage bottle is passed through the first (larger) hole portion and made to slid along the elongated through hole towards the second (narrower) hole portion, until the narrowing of the through hole prevents the bottle neck from further sliding thereby allowing the bottle neck to be retained by frictional engaging with the hole walls. Therefore, beverage bottles having bottle necks of different size may be accommodated and retained (the exact position, along the through hole, at which the bottler neck is retained depending for example on the size of the bottle neck and/or on the profile of the through hole).

According to an alternative embodiment of the present invention, the opening (or at least a portion thereof) is an adjustable opening that is adjustable according to the size of the bottle neck. Preferably, the device 100 further comprises an adjustable clamping member defining said adjustable opening and retaining the bottle neck of the beverage bottle.

An example of adjustable clamping member is shown in FIGS. 1A and 1B and denoted by the number reference 130. In this example, the adjustable clamping member 130 comprises a collar, preferably (as illustrated) a C-shaped collar, such that a distance between free ends of the C-shaped collar define the adjustable opening. The C-shaped collar is preferably formed in an elongated through hole 135 of the horizontal arm 105₁, the C-shaped collar being preferably formed at a first end 135₁ of the elongated through hole 135 of the horizontal arm 105₁. A second end 135₂ of the elongated through hole 135, opposite to the first end 135₁, is advantageously adapted to allow the passage of the bottle neck through it. Similarly to the above, the elongated through hole 135 of the horizontal arm 105₁ is advantageously obtained by corresponding elongated through holes formed on the horizontal and vertical arms of the inner 110 and outer 115 shells.

Preferably, the C-shaped collar is made of a material having both stiffness and resilient properties. More preferably the C-shaped collar is made of the same material as the inner shell 110 of the device 100, the C-shaped collar being for example made in a single piece with the inner shell 110 of the device 100. The resilient properties of the material of the C-shaped collar advantageously allow the C-shaped collar to be “enlarged” from a rest or closed or semi-closed condition (i.e., absence of a bottle neck), in which the distance between the free ends of the C-shaped collar has a minimum value, to an operative condition (i.e., presence of a bottle neck, as shown in FIG. 1C), in which the distance between the free ends of the C-shaped collar has a second value higher than the minimum value (and depending on the size of the bottle neck), the retaining action of the C-shaped collar being determined by natural resilient closing back of the free ends of the C-shaped collar to the rest condition. On the other side, the stiffness properties of the material of the C-shaped collar advantageously allow the C-shaped collar to rigidly retain the bottle neck of the beverage bottle.

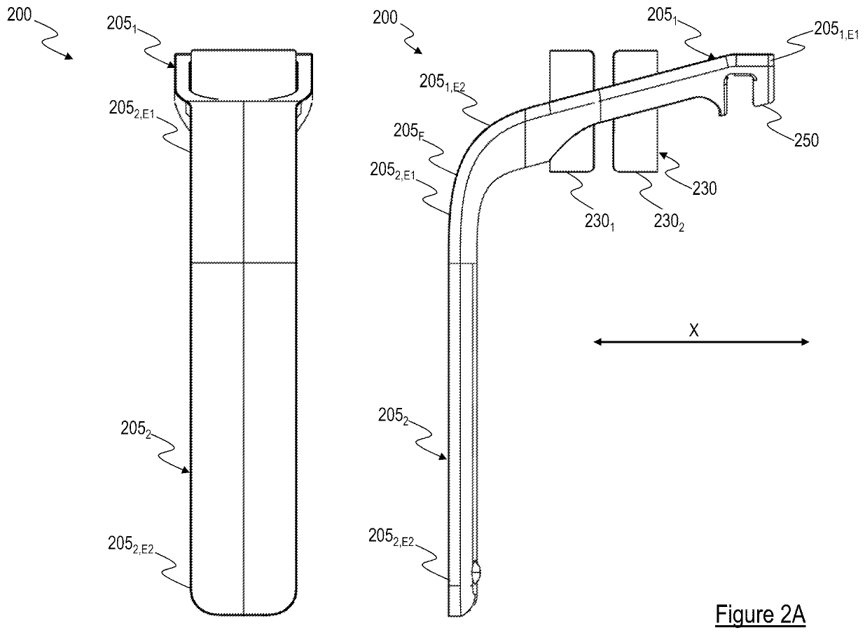

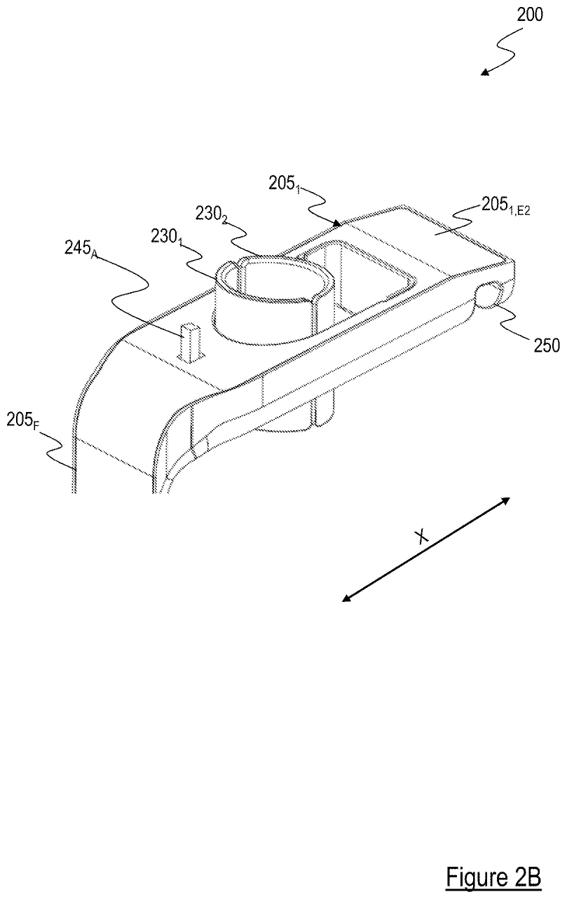

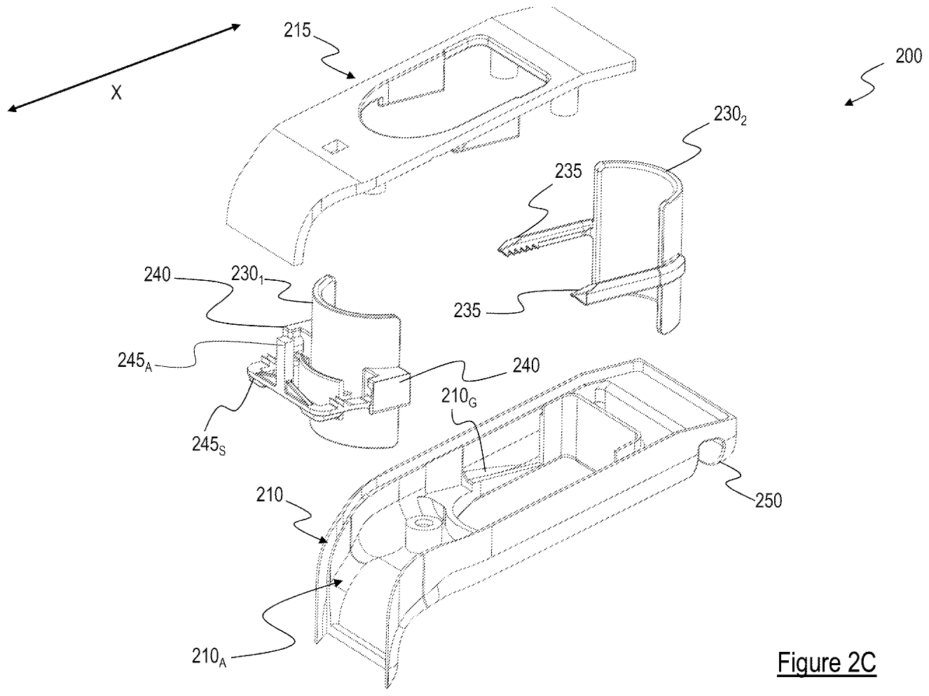

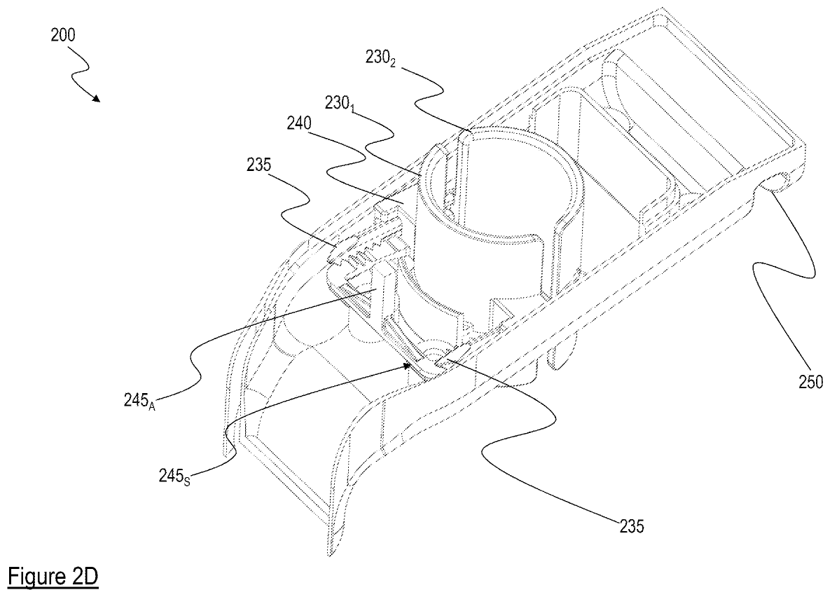

Another example of adjustable clamping member is shown in FIGS. 2A-2D and denoted by the number reference 230. Particularly, FIG. 2A shows front and side views of a device 200 according to another embodiment of the present invention (the device 200 being substantially equivalent to the device 100, exception made for the adjustable clamping member 230 and for structural adaptations of the horizontal arm 2051, and particularly of inner 210 and outer 215 shells thereof, to the adjustable clamping member 230), and FIGS. 2B, 2C and 2D are a perspective view, a partly exploded perspective view, and a perspective view with partly removed parts, respectively, of a portion of the device 200 including the adjustable clamping so member 230 (for ease of representation, the portion of the device 200 shown in FIGS. 2B-2D is strictly limited to parts of the horizontal arm 205₁ (and, hence, of parts of inner 210 and outer 215 shells thereof) having an actual interaction with the adjustable clamping member 230).

As visible in the figures, the adjustable clamping member 230 comprises first 230₁ and second 230₂ semicircular portions (preferably each one in the form of a C-shaped collar) moveable with respect to each other along a longitudinal direction X (the longitudinal direction X being essentially the direction identified by the horizontal arm 205₁ and also representing, in this embodiment, the moving direction of the first 230₁ and second 230₂ semicircular portions), such that a distance between the first 230₁ and second 230₂ semicircular portions along the longitudinal direction X define the adjustable opening for accommodating and retaining the bottle neck of the beverage bottle.

Preferably, as herein assumed, the first semicircular portion 230₁ is fixed (whereby in the following it will be referred to as fixed semicircular portion 230₁), whereas the second semicircular portion 230₂ is moveable with respect to the fixed semicircular portion 230₁ (whereby in the following it will be referred to as moveable semicircular portion 230₂).

Preferably, as illustrated in FIGS. 2C and 2D, the adjustable clamping member 230 comprises a locking system for locking in a releasable manner the fixed 230₁ and moveable 230₂ semicircular portions to each other around and in contact to the bottle neck. More preferably, the locking system comprises one or more (preferably two) bars 235, preferably made in a single piece with the moveable semicircular portion 230₂ and extending from respective sides thereof along the longitudinal direction X, and one or more (preferably, two) receptacles 240, preferably made in a single piece with the fixed semicircular portion 230₁ and located at respective sides thereof.

Each receptacle 240 is preferably adapted to receive and engage a respective bar 235, so as to lock the moveable semicircular portion 230₂ at a selected distance from the fixed semicircular portion 230₁. The bars 235 and the respective receptacles 240 preferably define a ratchet mechanism: in order to achieve that, each bar 235 and each receptacle 240 preferably comprise mutually engaging barb surface portions (i.e., portions having surfaces including a number of barbs or projections or teeth) enabling engaging between the bar 235 and the respective receptacle 240 when the bar 235 is being fitted into the receptacle 240, but preventing removal of the bar 235 out of the receptacle 240. Therefore, the moveable semicircular portion 230₂ can be locked at a selected distance from the fixed semicircular portion 230₁ according to a fitting extent of the bars 235 into the respective receptacles 240.

Advantageously, as illustrated, the locking system is associated with a release mechanism for allowing the user to selectively release the locking of the fixed 230₁ and moveable 230₂ semicircular portions. More advantageously, the release mechanism comprises an actuator 245_{A} (e.g., a mechanical pin or rod) adapted to be actuated by the user at an actuation end thereof, and an arm structure 245_{S} mechanically coupling an end of the actuator 245_{A} opposite to the actuation end to the barb surface portions of each receptacle 240. Therefore, upon actuation of the actuator 245_{A} (e.g., by pushing it downwards), the action of the arm structure 245_{S} allows the barb surface portions of the receptacles 240 to be pushed downwards, thereby disengaging them from the barb surface portions of the bars 235 and allowing the removal of the bars 235 out of the respective receptacles 240.

The fixed 230₁ and moveable 230₂ semicircular portions are preferably arranged in, and preferably protrudes from, an elongated through hole of the horizontal arm 205₁. More preferably, the inner shell 210 (and, particularly, the horizontal arm thereof) is advantageously provided (for example, at an end of the through hole of the inner shell 210) with an accommodating portion 210A for accommodating the fixed semicircular portion 230₁ and the release mechanism 245_{A},245_{S} coupled thereto (the fixed semicircular portion 230₁ and the release mechanism 245_{A},245_{S} coupled thereto being for example kept in the fixed position upon superimposition and coupling between the inner 205 and outer 210 shells), and is advantageously provided (e.g., at sides of the through hole of the inner shell 210) with horizontal or substantially horizontal guide portions 210_{G} (only one visible in FIG. 2C) for supporting the moveable semicircular portion 230₂ in correspondence of its bars 235 (with each bar 235 that preferably is supported by a respective guide portion 210G) and allowing the movement of the bars 235 along the longitudinal direction X.

As visible in FIG. 2C, the actuator 245_{A} preferably protrudes from the horizontal arm 205₁ (so that it can be actuated by the user), the actuator 245_{A} for example passing through a corresponding, e.g. dedicated, through hole of the outer shell 215.

Another example of adjustable clamping member may provide two semicircular portions hinged to each other at respective ends so that the semicircular portions are rotatable with respect to each other, and a locking system for locking in a releasable manner free ends of the semicircular portions to each other around and in contact to the bottle neck, such that the distance between the free ends of the semicircular portions define the adjustable opening.

According to an embodiment of the present invention, not shown, the semicircular portions are similar to the first 230₁ and second 230₂ semicircular portions; in this embodiment, the locking system may advantageously be based on frictional engaging, the locking system for example comprising mutually engaging barb surface portions (e.g., functionally similar to the previous embodiment) preferably provided at the free ends of the semicircular portions. As an alternative, the locking system may be based on snap-fit engaging, magnetic coupling or the like.

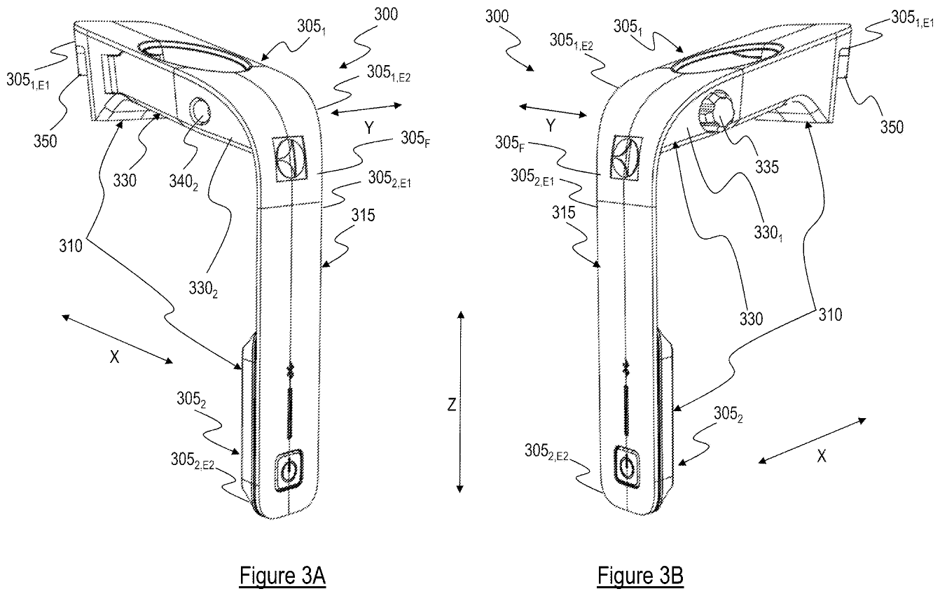

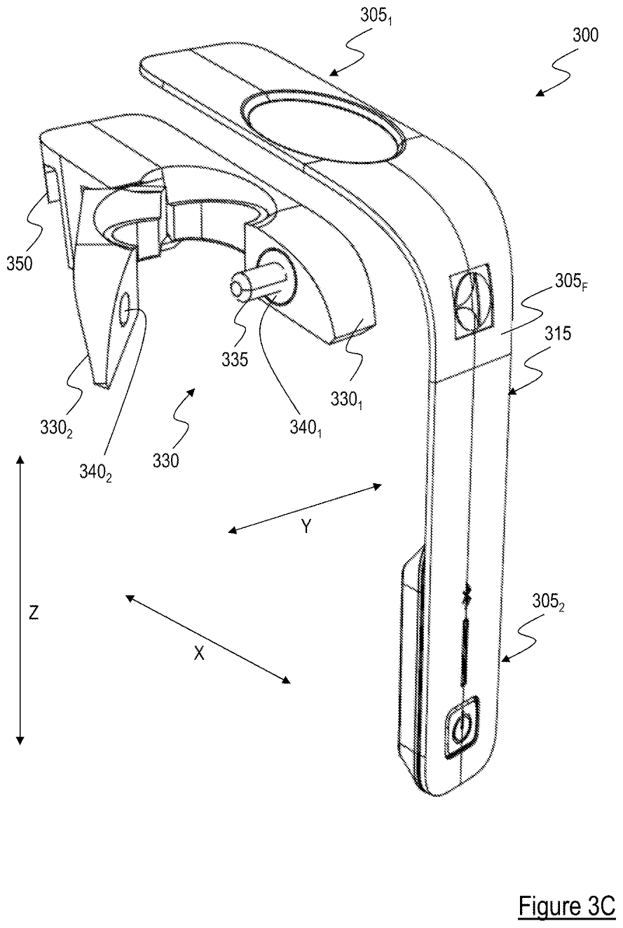

Another embodiment of adjusting clamping member based on two semicircular portions hinged to each other and rotatable with respect to each other is shown in FIGS. 3A-3C and denoted by the number reference 330. Particularly, FIGS. 3A and 3B show perspective side views of a device 300 according to another embodiment of the present invention (the device 300 being substantially equivalent to the devices 100 and 200, exception made for the adjustable clamping member 330 and for structural adaptations of the horizontal 305₁ and vertical arms 305₂ (and particularly of the inner shell 310) to the adjustable clamping member 330), and FIG. 3C shows a perspective and partially exploded side view of the device 300.

As visible in these figures, the outer shell 315 of the device 300 is preferably similar to the outer shells 115 and 215 of the devices 100 and 200, respectively, whereas the inner shell 310 of the device 300 comprises two distinct and separate pieces or members (i.e., a vertical piece of the inner shell 310 located in correspondence of the vertical arm of the outer shell 315 and a horizontal piece of the inner shell 310 located in correspondence of the horizontal arm of the outer shell 315). However, as should be readily understood, in alternative embodiments of the present invention, not illustrated, the inner shell 310 may be similar to the inner shells 110 and 210, i.e. with horizontal and vertical arms of the inner shell formed in a single piece and substantially following the whole profile of the outer shell 315; dually, the possibility that the devices 100 and/or 200 feature inner shells having two or more distinct and separate pieces or members (similarly to the inner shell 310) is not excluded.

The vertical piece of the inner shell 310 is preferably adapted to house the temperature measuring unit 120, the wireless communication unit 125 and the wire electrical connections (not visible); the vertical piece of the inner shell 310 is preferably located at the free end of the vertical arm of the outer shell 315 of the device 300 (instead of extending along the whole length of the outer shell 315, as instead is in the devices 100 and 200) and identifies, together with the vertical arm of the outer shell 315, the vertical arm 305₂ of the device 300.

Preferably, the horizontal piece of the inner shell 310 comprises incorporates (i.e., a portion thereof is adapted to act as) the adjustable clamping member 330. The adjustable clamping member 330 preferably has first 330₁ and second 330₂ semicircular portions rotatable with respect to each other. Preferably, as illustrated, the first semicircular portion 330₁ is fixed (whereby in the following it will be referred to as fixed semicircular portion 330₁), whereas the second semicircular portion 330₂ is moveable with respect to the fixed semicircular portion 330₁ (whereby in the following it will be referred to as moveable semicircular portion 330₂). Differently from the fixed 230₁ and movable 230₂ semicircular portions of the device 200, which are each one in the form of a C-shaped collar, the fixed 330₁ and movable 330₂ semicircular portions of the device 300 comprise each one a substantially parallepiped-shaped piece (which also forms part of the horizontal piece of the inner shell 310) with a half-moon shaped hollow. Each half-moon shaped hollow preferably extends along a transversal direction Y orthogonal to the longitudinal direction X; preferably, as illustrated, the half-moon shaped hollows feature mutually opposite orientations, so that, when the movable semicircular portion 330₂ abuts (or is in proximity of) the fixed semicircular portion 330₁, the two half-moon shaped hollows define a substantially circular passage for the passage of the bottle neck of the beverage bottle.

Preferably, the fixed 330₁ and movable 330₂ semicircular portions are hinged to each other along a vertical direction Z orthogonal to the longitudinal X and transversal Y directions (the vertical direction Z being essentially the direction identified by the vertical arm 305₂), whereby the movable semicircular portion 330₂ rotates with respect to the fixed semicircular portion 330₁ about the vertical direction Z on a rotation plane X-Y (i.e., the plane identified by the longitudinal X and transversal Y directions). Therefore, the distance between the fixed 330₁ and movable 330₂ semicircular portions on the rotation plane X-Y defines the adjustable opening for accommodating and retaining the bottle neck of the beverage bottle.

Preferably, as illustrated, the adjustable clamping member 330 comprises a locking system for locking in a releasable manner the fixed 330₁ and moveable 330₂ semicircular portions to each other around and in contact to the bottle neck. More preferably, the locking system comprises a screw 335 adapted to be screwed into through holes 340₁,340₂, preferably threaded through holes 340₁,340₂, respectively provided at a free end of the fixed 330₁ and moveable 330₂ semicircular portions (preferably, as illustrated at the curved end adapted to fit the curved connection section that connects the horizontal and vertical arms of the outer shell 315 to each other). As should be readily understood, other mechanical couplings may be provided instead of the screw 335 and/or of the through holes 340₁,340₂: just as an example, other nail-shaped or rod-shaped piece designed to be inserted into material by rotation or pushing may be provided instead of the screw 335.

Therefore, the moveable semicircular portion 330₂ can be locked at a selected distance from the fixed semicircular portion 330₁ according to a screwing extent of the screw 335 into the through holes 340₁,340₂.

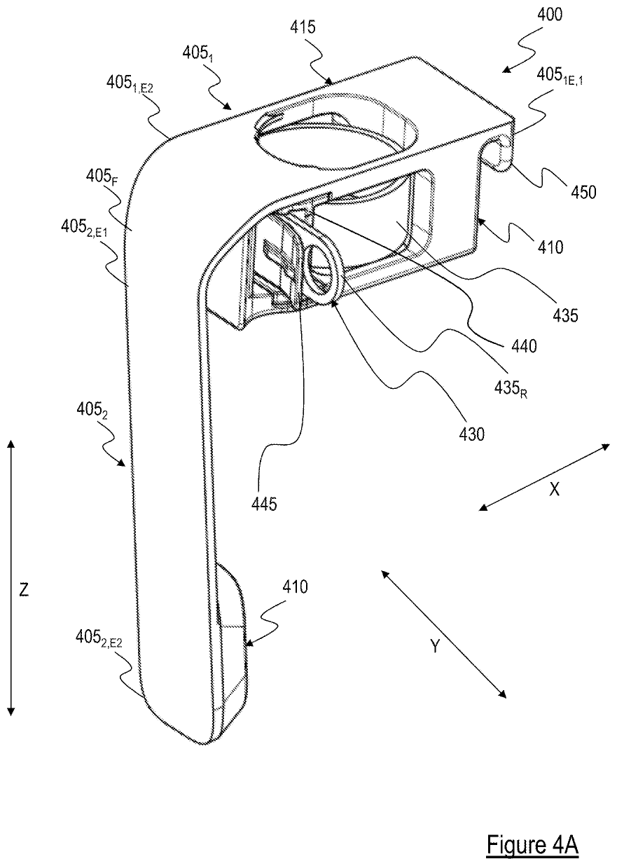

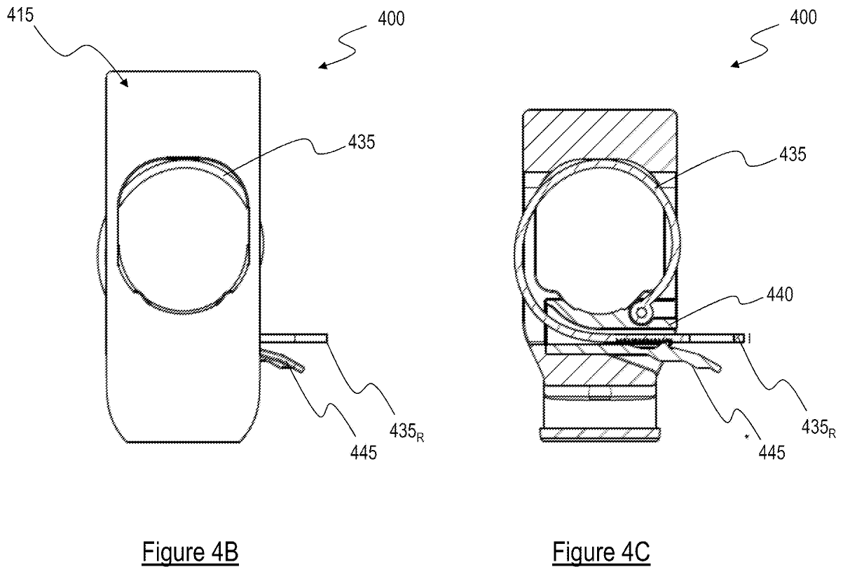

Another example of adjustable clamping member is shown in FIGS. 4A-4B and denoted by the number reference 430. Particularly, FIG. 4A shows a perspective side view of a device 400 according to another embodiment of the present invention (the device 400 being substantially equivalent to the device 300, exception made for the adjustable clamping member 430 and for structural adaptations of the horizontal arm 405₁, and particularly of the inner shell 410 thereof, to the adjustable clamping member 430), and FIGS. 4B and 4C show a view from above and a sectional view from above, respectively, of the device 400.

As visible in these figures, the device 400 comprises an outer shell 415 that, preferably, is similar to the outer shells 115, 215, and 315 of the devices 100, 200 and 300, respectively, and an inner shell 410 that, in the exemplary considered embodiment, is similar to the inner shell 310 of the device 300 (i.e. it comprises two distinct and separate pieces or members, namely a vertical piece of the inner shell 410 located in correspondence of the vertical arm of the outer shell 415 and a horizontal piece of the inner shell 410 located in correspondence of the horizontal arm of the outer shell 415).

Similarly to the vertical piece of the inner shell 310, the vertical piece of the inner shell 410 is preferably adapted to house the temperature measuring unit 120, the wireless communication unit 125 and the wire electrical connections (not visible), and is preferably located at the free end of the vertical arm of the outer shell 415.

Preferably, the horizontal piece of the inner shell 410 comprises a hollow parallelepiped shaped case adapted to house the adjustable clamping member 430.

As visible in the figures, the adjustable clamping member 430 preferably comprises a tie 435 having a flexible tape section adapted to be housed in the hollow of the horizontal piece of the inner shell 410 in a substantially circular bent configuration, and an end section adapted to be fitted into a head or receptacle 440 (which may be a part of the vertical piece of the inner shell 410 or a separate part housed therein). The flexible tape section of the tie 435 (or a portion thereof) preferably comprises teeth (visible in FIG. 4C) adapted to engage with the head 440 to form a ratchet mechanism (similarly to the ratchet mechanism implemented by the bars 235 and the receptacles 240 of the device 200), so that when a free end of the tie 435 is pulled, the flexible tape section of the tie 435 is fitted into the head 440 and engages with (but is prevented from being removed from) it, thus tightening around the bottle neck of the beverage bottle. Therefore, a fitting extent of the tie 435 into the head 440 defines the adjustable opening of the adjustable clamping member 430.

Advantageously, as illustrated, in order to make the pulling of the tie 435 easy, the end section of the tie 435 comprises a pulling ring 435R, into which the user can put his/her finger for exerting the pulling action. In this embodiment, the transversal direction Y identifies the direction along which the pulling action is exerted.

Advantageously, the clamping member 430 comprises a release mechanism for allowing the user to selectively release the engaging between the tie 435 and the head 440. More advantageously, the release mechanism comprises a tab 445 that can be depressed to release the ratchet so that the tie 435 can be loosened (the complete removal of the tie 435 being advantageously prevented by the larger size of the pulling ring 435R as compared to the size of the rest of the tie 435), so as to be able to tighten the tie 435 around a bottle neck of a different beverage bottle.

Advantageously, in all the above examples of adjustable clamping member, the adjustable clamping member may comprise, on at least part of a contact region thereof that in use is in contact with the bottle neck, a grip element (not shown) for improving an adherence between the contact region and the bottle neck of the beverage bottle.

Although in the foregoing the retaining function of the bottle neck has been discussed as accomplished by the opening of the horizontal arm or, according to the discussed examples, by adjustable openings defined by adjustable clamping members, implementations may be provided in which no opening is provided in the horizontal arm and the accommodating and retaining function is accomplished entirely by any other suitable clamping member.

Back to the figures a hooking element (or more thereof) may be provided in the device 100 (see the hooking element 150 in FIGS. 1A-1C), and/or in the device 200 (see the hooking element 250 in FIGS. 2A-2D), and/or in the device 300 (see the hooking element 350 in FIGS. 3A-3C) and/or in the device 400 (see the hooking element 450 in FIGS. 4A and 4B) for hooking the device 100,200,300,400 to a support element (not shown in this figure) thereby allowing the beverage bottle to be supported in a hanged position. The hooking element 150,250,350,450 is preferably formed in the horizontal arm 105₁,205₁,305₁,405₁, the hooking element 150,250,350,450 being for example formed in a single piece with the horizontal arm 105₁,205₁,3051,405₁. More preferably (as illustrated), the hooking element 150,250,350,450 is formed in correspondence of the free end 105_{1,E1},205_{1,E1},305_{1,E1},405_{1,E1} of the horizontal arm 105₁,205₁,305₁,405₁ (so as to form an appendix thereof), and even more preferably it is formed in correspondence of the free end of the horizontal arm of the inner shell 110,210,310,410 (so as to form an appendix thereof)—the opposite end 105_{1,E2},205_{1,E2},305_{1,E2},305_{1,E2} of the horizontal arm 105₁,205₁,305₁,405₁ being instead close to the flexible region 105_{F},205_{F},305_{F},405_{F} that, preferably interposed between the end 105_{1,E2},205_{1,E2},305_{1,E2},305_{1,E2} of the horizontal arm 105₁,205₁,3051,405₁ and the end 105_{2,E1},205_{2,E1},305_{2,E1},305_{2,E1}of the vertical arm 105₂,205₂,305₂ ,405₂ opposite to the free end 105_{2,E2},205_{2,E2},305_{2,E2},305_{2,E2} of the vertical arm 105₂,205₂,305₂ ,405₂, allows resilient flexing of the vertical arm 105₂,205₂,305₂,405₂ with respect to the horizontal arm 105₁,205₁,305₁,405₁.

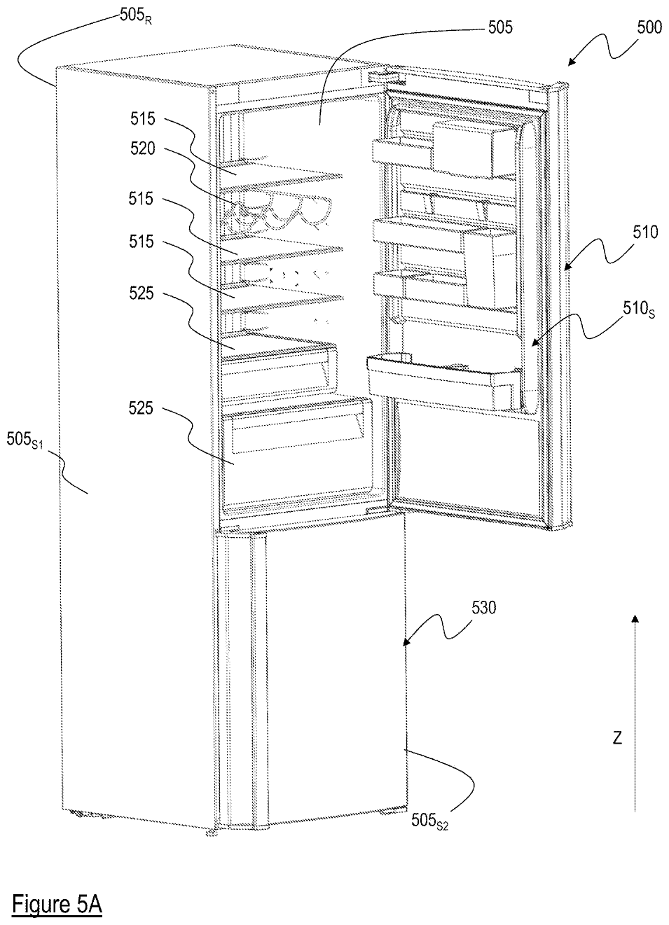

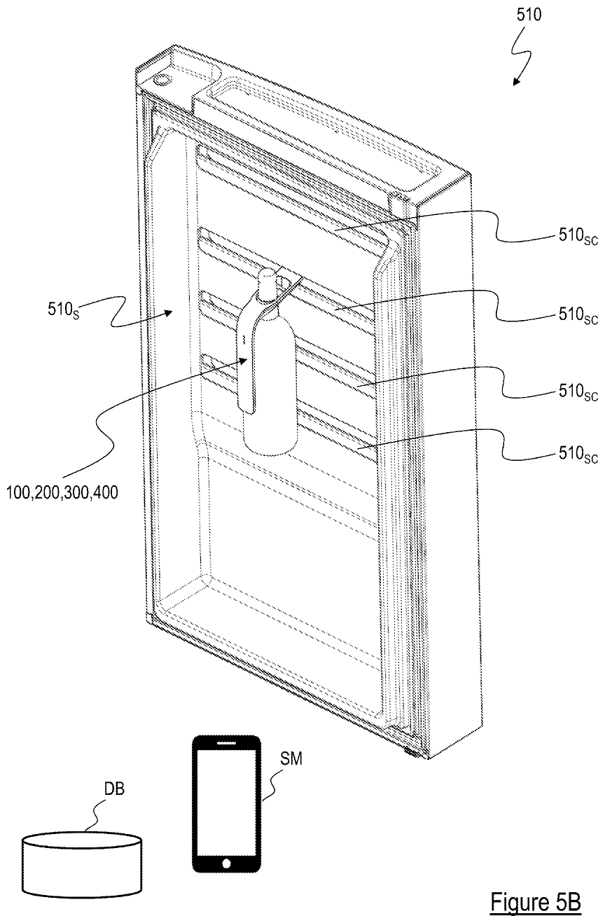

With reference now also to FIGS. 5A and 5B, FIG. 5A shows, according to an embodiment of the present invention, a perspective view of a refrigerating apparatus 500 on which the device 100,200,300,400 may be supported in the hanged position, and FIG. 5B shows a perspective view of a door of the refrigerating apparatus 500 and the device/bottle assembly supported on it in the hanged position, according to an embodiment of the present invention.

In the following, directional terminology (for example, upper, lower, side, left, right, longitudinal, vertical, transverse) associated with the refrigerating apparatus 500 and components thereof (for example, accessories for the organized positioning of the products to be refrigerated) will be used only in connection with their orientation in the figures, which is assumed to be their orientation of use (i.e., the orientation taken when the refrigerating apparatus 500 is installed in the user premises and the accessories mounted on it).

The refrigerating apparatus 500 comprises a refrigerating compartment 505 (for example, a fridge compartment) for housing products to be refrigerated. The fridge compartment 505 is preferably delimited by a rear wall 505_{R} and side walls 505_{S1},505_{S2}. Preferably, as herein assumed, the rear wall 505_{R} extends along a vertical direction Z (taking the refrigerating apparatus 500 installed in the user premises as a reference, the refrigerating apparatus 500 has a height along the vertical direction Z), and, preferably, the side walls 505_{S1},505_{S2} extend along the vertical direction Z parallel to each other and orthogonal to the rear wall 505_{R}. The refrigerating apparatus 500 further comprises a door 510 (shown in an open position) for selectively closing the fridge compartment 505, the door 510 facing the rear wall 505_{R} (and, in the considered example, being parallel thereto) when the door 510 is in a closed position.

Preferably, although not necessarily, the fridge compartment 505 comprises, within it, one or more accessories for the organized positioning of the products to be refrigerated, such as one or more shelves (such as the shelves 515 exemplary illustrated), and/or one or more bottle-holder components (such as the bottle-holder element 520 exemplary illustrated) and/or one or more drawers (such as the drawers 525 exemplary illustrated) and/or others.

In the exemplary considered embodiment, the refrigerating apparatus 500 comprises a further refrigerating compartment (for example, a freezer compartment) and a door 530 associated with it (the freezer compartment being not visible in the figures as it is covered by the respective door 530 in the closed position). As will be apparent from the following description, the device/bottle assembly may be indistinctly coupled either to the door 510 of the fridge compartment 505 or to the door 530 of the freezer compartment—however, for the sake of exposition simplicity and brevity, only a device/bottle assembly coupled to the door 510 of the fridge compartment 505 will be considered.

The device 100,200,300,400 (and the beverage bottle on which it is mounted) is adapted to be hanged on a support panel coupled to an inner liner of the door 510 (the inner liner being positioned opposite to an external surface of the door 510 that, when the door 510 is closed, faces the external of the fridge compartment 505). The support panel is indicated in the figure by the number reference 510_{S}, and is preferably the same as the support panel disclosed in WO2016134987, whose description is incorporated herein by reference.

For the purposes of the present disclosure, the support panel 510_{S} comprises one or more support elements 510_{SC}, preferably in the form of crossbars. Each crossbar 510_{SC} preferably comprises a front zone that defines, together with the front zones of the other crossbars, a front face (or surface) of the support panel 510_{S}, and a rear zone that defines, together with the rear zones of the other crossbars, a rear face (or surface) of the support panel 510_{S}.

In the exemplary illustrated embodiment, each crossbar 510_{SC} defines within it (i.e., between the respective front and rear zones) a rail to allow the hooking and the free positioning of the device/bottle assembly along it, with the hooking element 150,250,350,450 that is preferably shaped such as to hook and rest on the rail top edge.

In the exemplary illustrated and discussed embodiments, the devices 100 to 400 comprise first and second arms defining a substantially L-shaped profile. However, another embodiment of the present invention comprises a measuring device (not shown) that comprises a clamping member for accommodating and retaining the bottle neck of the beverage bottle, one or more hooking elements for hooking the device to a support element thereby allowing the beverage bottle to be supported in a hanged position, a temperature measuring unit facing the beverage bottle when the measuring device is coupled to the beverage bottle, and a wireless communication unit coupled to the temperature measuring unit and adapted to wirelessly communicate with a display unit arranged to provide an indication associated with the temperature of the beverage bottle as measured by the temperature measuring unit.

In other words, an embodiment of the present invention comprises a measuring device, for example similar to the devices 100 to 400 (but having different structure), it being understood that all the advantageous features discussed above for the devices 100 to 400 are intended to equivalently apply to such a measuring device. Just as an example, the measuring device may comprise a first part comprising the hooking element(s), and preferably the clamping member, and a second part adapted to accommodate said temperature measuring unit, but with the second part that may for example be in the form of a horizontal plate or vessel or tray or base adapted to house at least partially the beverage bottle in a standing position and with the first part that may be in the form of an elongated member vertically projecting from the first part upwards (taking as reference the measuring device in its operating position). Just as another example, the measuring device may comprise a single part or piece comprising the hooking element(s), the clamping member and the temperature measuring unit, with the measuring device that may for example be in the form of a collar or other non-solid shape adapted to be placed around the bottle neck (or around any other suitable part of the beverage bottle); in alternative embodiments, the measuring device may be in the form of a solid shape associated with a (e.g., rigid or resilient) band adapted to fix the measuring device around the bottle neck (or around any other suitable part of the beverage bottle).

As mentioned above, the wireless communication unit 125 is arranged to communicate wirelessly with a display device. The display device may be a mobile telephone, tablet PC or any other portable computing device preferably arranged to run an application for notifying (e.g., displaying) the temperature of the beverage bottle as measured by the temperature measuring unit 120. As mentioned above, an example of such a display device is a smartphone (illustrated in FIG. 5B and denoted by the reference SM).

According to an embodiment, the application may notify (e.g., display) the current temperature information which is transmitted from the temperature measuring unit 120. For example, the application may display the current temperature of a wine bottle on which the temperature measuring unit 120 has been placed. Additionally or alternatively, the application may determine and display an estimated time for the beverage bottle to reach the target or desired temperature when the device/bottle assembly is placed in the refrigerating apparatus.

Advantageously, the user may be able to specify, and input to the smartphone SM, one or more parameters of the beverage bottle.

For example, the user may be able to manually specify a temperature range (or a specific target temperature) which is desired for the beverage bottle. For example, the temperature range may be a predefined temperature range (or a specific target temperature) dependent on the type of the beverage, for example dependent on the type of wine. The user may be able to navigate a menu system of the application to select the type of wine and set the required temperature range. In an example the application may comprise one or more interactive features which enable the user to navigate menus to select a predefined temperature range for a specific type of wine or to enable a user to specify a temperature range (or a specific target temperature) or adjust a predefined temperature range (or a predefined target temperature). In an example, the interactive features may be touch screen features, such as touch screen menu buttons. As better discussed below, the temperature range or the target temperature may be automatically acquired by the application. Regardless of the (manual or automatic) acquisition mode of the target temperature (or temperature range), the application may be advantageously configured to automatically set the device 100-400 with the acquired target temperature (or temperature range), for example when at least part of the smart functionalities of the smartphone SM (such as, for example, the notification that the beverage bottle has reached the target temperature) are intended to be implemented in the device 100-400.

In other examples the application may additionally display other information, for example; the type of wine selected, the target temperature, an estimated time for the wine to reach the target temperature, and a secondary indicator. The secondary indicator may indicate, for example, when the temperature measuring unit detects that the temperature of the wine bottle is below the specified temperature range, when the temperature range is above the specified temperature range or within the specified temperature range. The secondary indicator may further indicate when the temperature measuring unit detects that the wine is at an ideal serving temperature. According to embodiments of the present invention, the secondary indicator may comprise a colour indication (the colour of a display or a display portion of the smartphone SM may for example change to indicate via colour whether the measured temperature is within the appropriate range), in addition or in alternative to text or image indications.

In the embodiments described above, the one or more predefined temperature ranges may be predefined temperature ranges dependent on the type of wine, for example, sparkling white wine, light bodied white wine and rose wine (6-8° C.), dessert wine (7-10° C.), vintage sparkling wine (8-10° C.), medium white wine (9-11° C.), light bodied red wine (10-12° C.), full bodied white wine (10-13°C.), medium bodied red wine (14-16° C.) and full bodied red wine (16-18° C.).

In another example the user may be able to adjust the predefined ranges or specify their own preferred preset ranges based on a plurality of factors, for example, ambient temperature, food type, personal preference, seasonality or grape variety.

In the embodiments described above, the smartphone SM (or other mobile computing device) may incorporate a camera or other device which enables it to read labels (for example, barcodes, OR codes or any other written or printed identifications or information) found on bottles, with the smartphone SM (or other mobile computing device) that may be equipped with proper text and/or image recognition features for recognizing the information contents of the labels (for example, the target or ideal serving temperatures or temperature ranges of the respective beverage bottles). In an example, data from a barcode (or other label) may be used to access information relating to a wine, for example, appropriate serving temperature range, food matches and the like, which in an example may be displayed at the display unit or application. According to an embodiment, the recognized information content of the label comprises a wine identifier (such as wine name and/or wine type and/or any other identifier allowing to univocally identify the wine), and the target temperature for the identified wine may be retrieved automatically by the smartphone SM (i.e., by exploiting the functionalities of the corresponding application running in it) by accessing either a local wine database (for example, a wine database locally stored in the smartphone SM and preferably downloaded contextually with the application download and installation), or a remote wine database DB (for example, by connection of the smartphone SM to the remote wine database through 2G, 3G or 4G cellular connection, and by automatic authentication and access of the smartphone SM to the remote wine database DB through a valid account registered on the application).

Naturally, in order to satisfy local and specific requirements, a person skilled in the art may apply to the present invention many logical and/or physical modifications and alterations. More specifically, although the present invention has been described with a certain degree of particularity with reference to one or more embodiments thereof, it should be understood that various omissions, substitutions and changes in the form and details as well as other embodiments are possible. Particularly, different embodiments of the invention may even be practiced without the specific details; conversely, well-known features may have been omitted or simplified in order not to obscure the description with unnecessary particulars.

Moreover, it is expressly intended that specific elements described in connection with any embodiment of the disclosed invention may be incorporated in any other embodiment as a matter of general design choice.

Amendments to the claims:

1. A device (100; 200; 300; 400) comprising:
a first arm (1051; 2051; 3051; 4051) adapted to accommodate and retain a bottle neck of a beverage bottle;
a second arm (1052; 2052; 3052; 4052) extending from the first arm (1051; 2051; 3051;
4051), the second arm (1052; 2052; 3052; 4052) being configured to extend towards a bottle body of the beverage bottle when the device (100; 200; 300; 400) is mounted on the beverage bottle;
a temperature measuring unit (120) housed in the second arm (1052; 2052; 3052: 4052), the temperature measuring unit (120) facing the bottle body when the device (100; 200; 300; 400) is mounted on the beverage bottle, and
a wireless communication unit (125) coupled to the temperature measuring unit (120),
wherein the wireless communication unit (125) is adapted to wirelessly communicate with a display unit arranged to provide an indication associated with the temperature of the beverage bottle as measured by the temperature measuring unit (120).

2. The device (100; 200; 300; 400) according to claim 1 wherein the first arm (1051; 2051; 3051; 4051) comprises at least one hooking element (150; 250; 350; 450) for hooking the device (100; 200; 300; 400) to a support element thereby allowing the beverage bottle to be supported in a hanged position.

3. The device (100; 200; 300; 400) according to claim 1, wherein the first arm (1051; 2051; 3051; 4051) comprises an adjustable clamping member (130; 230; 330; 430) for accommodating and retaining the bottle neck of the beverage bottle.

4. The device (100; 200; 300; 400) according to claim 1, wherein the first arm (1051; 2051; 3051; 4051) comprises an opening for accommodating and retaining the bottle neck of the beverage bottle.

5. The device (100; 200; 300; 400) according to claim 4, wherein said opening comprises a first portion for the passage of the bottle neck through it, and a second portion, reduced in size with respect to the first portion, for accommodating and retaining the bottle neck of the beverage bottle.

6. The device (100; 200; 300; 400) according to claim 4, wherein said opening is an adjustable opening that is adjustable according to a size of the bottle neck, the device (100; 200; 300; 400) further comprising an adjustable clamping member (130; 230; 330; 430) defining said adjustable opening and retaining the bottle neck of the beverage bottle.

7. The device (200) according to claim 6, wherein the adjustable clamping member (230) comprises:
first (2301) and second (2302) semicircular portions moveable with respect to each other along a moving direction (X), a distance between the first (2301) and second (2302) semicircular portions along said moving direction (X) defining said adjustable opening, and
a locking system (235,240) for locking in a releasable manner the first (2301) and second (2302) semicircular portions to each other around and in contact to the bottle neck.

8. The device (200) according to claim 7, further comprising a release mechanism (245A, 245S) for allowing the user to selectively release the locking of the first (2301) and second (2302) semicircular portions.

9. The device (300) according to claim 6, wherein the adjustable clamping member (330) comprises:
first (3301) and second (3302) semicircular portions, a first end of the first semicircular portion (3301) being hinged to a first end of the second semicircular portion (3302) whereby the first (3301) and second (3302) semicircular portions are rotatable with respect to each other;
a locking system (335,3401,3402) for locking in a releasable manner a second end of the first semicircular portion (3301) to a second end of the second semicircular portion (3302) around and in contact to the bottle neck, a distance between the second ends of the first and second semicircular portions defining said adjustable opening.

10. The device (400) according to claim 6, wherein the adjustable clamping member (430) comprises a tie (435) adapted to be fitted into and engage a receptacle (440) to form a releasable ratchet mechanism, a fitting extent of the tie (435) into the receptacle (440) defining said adjustable opening.

11. The device (200; 300; 400) according to any claim from 8 to 10, wherein the adjustable clamping member (230; 330; 430) comprises, on at least part of a contact region thereof that in use is in contact with the bottle neck, a grip element for improving an adherence between the contact region and the bottle neck of the beverage bottle.

12. The device (100; 200; 300; 400) according to claim 1, wherein the device arm (100; 200; 300; 400) comprises a flexible region (105F; 205F; 305F; 405F) for causing at least part of the second arm (1052; 2052; 3052; 4052) to resiliently flex with respect to the first arm (1051; 2051; 3051;4051) thereby allowing the second arm (1052; 2052; 3052; 4052) to adapt to a size of the bottle body.

13. The device (100; 200; 300; 400) according to claim 12, wherein the flexible region (105F; 205F; 305F; 405F) comprises a region of the second arm (1052; 2052; 3052; 4052) having a thickness lower than the thickness of the rest of the second arm (1052; 2052; 3052; 4052).

14. The device (100; 200; 300; 400) according to claim 12, wherein the flexible region (105F; 205F; 305F; 405F) comprises a hinging element arranged between the first (1051; 2051; 3051; 4051) and second (1052; 2052; 3052; 4052) arms or between first and second regions of the second arm (1052; 2052; 3052; 4052).

15. The device (100; 200; 300; 400) according to claim 12, wherein the flexible region (105F; 205F) comprises a region of the second arm (1052; 2052) having a flexible material overmolded thereon.

16. The device (100; 200; 300; 400) according to claim 1, wherein the wireless communication unit (125) is adapted to wirelessly communicate with a mobile computing apparatus (SM), comprising said display unit.

17. The device (100; 200; 300; 400) according to claim 1, wherein the wireless communication unit (125) is configured to wirelessly communicate based on at least one wireless communication mode among Wi-Fi communication, Bluetooth communication and radio frequency communication.

18. The device (100; 200; 300; 400) according to claim 17, wherein the wireless communication unit (125) is configured to select the wireless communication mode based on a current distance between the device (100; 200; 300; 400) and the mobile computing apparatus (SM).

19. The device (100; 200; 300; 400) according to claim 1, further comprising a temperature indicator located on the second arm (1052; 2052; 3052; 4052) and in wireless or wired communication with the temperature measuring unit (120) and configured to provide said indication associated with the temperature of the beverage bottle as measured by the temperature measuring unit (120).

20. The device (100; 200; 300; 400) according to claim 1, wherein the first (1051; 2051; 3051; 4051) and second (1052; 2052; 3052; 4052) arms define a substantially L-shaped profile of the device (100; 200; 300; 400).

21. The device (100; 200; 300; 400) according to claim 2, wherein the at least one hooking element (150; 250; 350; 450) is in correspondence of a first free end (1051,E1; 2051,E1; 3051,E1; 4051,E1) of the first arm (1051; 2051; 3051; 4051), the second arm (1052; 2052; 3052; 4052) having a first end (1052,E1; 2052,E1; 3052,E1; 4052,E1) coupled to a second end (1051,E2; 2051,E2; 3051,E2; 4051,E2) of the first arm (1051; 2051; 3051; 4051) opposite to the first free end (1051,E1; 2051,E1; 3051,E1; 4051,E1) of the first arm (1051; 2051;
3051; 4051), and a second free end (1052,E2; 2052, E2;3052, E2; 4052, E2) opposite to the first end (1052,E1; 2052, E1; 3052, E1; 4052,E1) of the second arm (1052; 2052; 3052; 4052).

22. The device (100; 200; 300; 400) according to claim 21, wherein the temperature measuring unit (120) is located in intermediate position along the second arm (1052; 2052; 3052; 4052), particularly closer to the second free end (1052,E2; 2052, E2; 3052, E2; 4052, E2) thereof than to the first end (1052,E1; 2052, E1; 3052, E1; 4052, E1) thereof.

23. The device (100; 200; 300; 400) according to claim from 2, wherein the at least one hooking element (150; 250; 350; 450) is formed in a single piece with the first arm (1051; 2051; 3051; 4051).

24. The device (100; 200; 300; 400) according to claim 1, wherein the first (1051; 2051; 3051; 4051) and second (1052; 2052; 3052; 4052) arms are made in a single piece.

25. The device (100; 200; 300; 400) according to claim 1, wherein said indication associated with the temperature of the beverage bottle provided by the display unit comprises an indication that the beverage bottle has reached a target temperature.

26. A device (100; 200; 300; 400) adapted to be coupled to a beverage bottle, the device (100; 200; 300; 400) comprising:
a clamping member (130; 230; 330; 430) for accommodating and retaining the bottle neck of the beverage bottle,
at least one hooking element (150; 250; 350; 450) for hooking the device (100; 200; 300; 400) to a support element thereby allowing the beverage bottle to be supported in a hanged position;
a temperature measuring unit (120), the temperature measuring unit (120) facing the beverage bottle when the device (100; 200; 300; 400) is coupled to the beverage bottle, and
a wireless communication unit (125) coupled to the temperature measuring unit (120) and adapted to wirelessly communicate with a display unit arranged to provide an indication associated with the temperature of the beverage bottle as measured by the temperature measuring unit (120).

27. A system (100; 200; 300; 400; DB; SM) comprising:
a device (100; 200; 300; 400) adapted to be mounted on a beverage bottle, wherein the device (100; 200; 300; 400) comprises a temperature measuring unit (120) facing the bottle body when the device (100; 200; 300; 400) is mounted on the beverage bottle, and a wireless communication unit (125) coupled to the temperature measuring unit (120),
a beverage bottle database (DB), and
a mobile computing apparatus (SM), comprising a display unit, the mobile computing apparatus (SM) being adapted to:
read a label on the beverage bottle;
access the beverage bottle database (DB) and retrieve from it a target temperature for the beverage bottle according to the label being read on the beverage bottle;
wirelessly communicate with the wireless communication unit (125) for receiving the temperature of the beverage bottle as measured by the temperature measuring unit (120), and
notify, for example by displaying on the display unit, an indication associated with the temperature of the beverage bottle as measured by the temperature measuring unit (120), wherein said indication associated with the temperature of the beverage bottle comprises an indication of the temperature of the beverage bottle with respect to the target temperature.

28. The system (100; 200; 300; 400; DB; SM) according to claim 27, wherein said indication associated with the temperature of the beverage bottle comprises one or more among a current temperature of the beverage bottle, temperature of the beverage bottle below and/or above and/or within a specified temperature range, and estimated cooling time to reach the target temperature.

29. The system (100; 200; 300; 400; DB; SM) according to claim 27, wherein said beverage bottle database (DB) is a local database locally stored in the mobile computing apparatus (SM) or a remote database remotely accessed by the mobile computing apparatus (SM).

30. Refrigerating apparatus (500) comprising a refrigerating compartment (505) and a door (510) for selectively closing the refrigerating compartment (505), wherein said door (510) comprises an external surface that forms an external appearance of the refrigerating apparatus, and an inner liner, opposite to said external surface and facing, when the door is closed, the refrigerating compartment (505), the inner liner comprising one or more support elements (510s) for supporting one or more storage elements adapted to store products to be refrigerated, characterized by comprising the device (100; 200; 300; 400) according to claim 1, wherein the device (100; 200; 300; 400) is adapted to be hung on said one or more support elements (510s) through the at least one hooking element (150; 250; 350; 450).
